(19) United States
(12) Patent Application Publication
(10) Pub. No.: US 2022/0267696 A1
(43) Pub. Date: Aug. 25, 2022

(54) METHOD FOR OPERATING REFRIGERANT CIRCULATION SYSTEM

(71) Applicant: ENEOS Corporation, Tokyo (JP)

(72) Inventors: Satoshi NAGAI, Tokyo (JP); Tatsuki NAKAJIMA, Tokyo (JP); Yuya MIZUTANI, Tokyo (JP); Hidetoshi OGATA, Toyko (JP)

(73) Assignee: ENEOS Corporation, Tokyo (JP)

(21) Appl. No.: 17/628,086

(22) PCT Filed: Jul. 17, 2020
(86) PCT No.: PCT/JP2020/027870

§ 371 Date: Jan. 18, 2022

(30) Foreign Application Priority Data
Jul. 25, 2019 (JP) 2019-137094

(51) Int. Cl. C10M 169/04; F25B 1/00; C10M 105/16; C10M 145/08; C09K 5/04

(52) U.S. Cl. CPC C10M 169/044; F25B 1/00; C10M 105/16; C10M 145/08; C09K 5/041; C10M 2207/0215; C09K 2205/102

(57) ABSTRACT

A method for operating a refrigerant circulation system comprising a compressor, a condenser, an expansion mechanism, and an evaporator connected in this order with piping, wherein a refrigerant comprising trifluoroiodomethane is used as a refrigerant; a refrigerating machine oil comprising, as a base oil, a polyolester synthesized from a polyhydric alcohol and fatty acids, with a proportion of a fatty acid having 9 carbon atoms in the fatty acids being 65 mol % or less is used as a refrigerating machine oil; and a temperature of an entire area of the refrigerant circulation system is kept at 160° C. or lower.

### TECHNICAL FIELD

The present invention relates to a method for operating a refrigerant circulation system.

### BACKGROUND ART

Refrigerating machines such as refrigerators and air conditioners comprise a refrigerant circulation system having a compressor, a condenser, an expansion mechanism (expansion valve, capillary), an evaporator, etc., and the refrigerant circulates within this refrigerant circulation system and thereby cooling is carried out.

The compressor in the refrigerant circulation system is filled with refrigerating machine oil so as to lubricate sliding members. The refrigerating machine oil dissolves in a refrigerant and circulates together with the refrigerant in the refrigerant circulation system. Refrigerating machine oil is used, with each physical property, including blending of additives, optimized according to desired characteristics such as lubricity and compatibility with a refrigerant.

Meanwhile, as a refrigerant circulating within a refrigerant circulation system, application of a refrigerant the global warming potential (GWP) of which is low and which is non-flammable has been considered in recent years for global warming countermeasures and measures in terms of safety. For example, in Patent Literature 1 described below, a refrigerant containing trifluoroiodomethane is proposed as a refrigerant.

### CITATION LIST

### Patent Literature

Patent Literature 1: Japanese Unexamined Patent Publication No. 2015-514827

### SUMMARY OF INVENTION

### Technical Problem

However, when a refrigerant containing trifluoroiodomethane is used as a refrigerant in a refrigerant circulation system for global warming countermeasures and measures in terms of safety, the stability of refrigerating machine oil is sometimes insufficient depending on the type of refrigerating machine oil used and the circulation conditions in the refrigerant circulation system.

The present invention aims to provide a method for operating a refrigerant circulation system capable of maintaining stability of refrigerating machine oil at a high level even when a refrigerant containing trifluoroiodomethane is used, as a refrigerant, in a refrigerant circulation system which the refrigerant fills.

### Solution to Problem

As a result of intensive studies to solve the above problem, the present inventors have found that the above problem can be solved by optimizing the type of refrigerating machine oil and the operating conditions of the refrigerant circulation system and completed the present invention.

That is, the present invention provides a method for operating a refrigerant circulation system comprising a compressor, a condenser, an expansion mechanism, and an evaporator connected in this order with piping, wherein a refrigerant comprising trifluoroiodomethane is used as a refrigerant; a refrigerating machine oil comprising, as a base oil, a polyolester synthesized from a polyhydric alcohol and fatty acids, with a proportion of a fatty acid having 9 carbon atoms in the fatty acids being 65 mol % or less is used as a refrigerating machine oil; and a temperature of an entire area of the refrigerant circulation system is kept at 160° C. or lower.

In the above-described method, the refrigerating machine oil may further comprise a hindered phenol compound.

In addition, in the above-described method, the refrigerating machine oil may further comprise an acid scavenger.

### Advantageous Effects of Invention

According to the present invention, a method for operating a refrigerant circulation system capable of maintaining stability of refrigerating machine oil at a high level even when a refrigerant containing trifluoroiodomethane is used, as a refrigerant, in a refrigerant circulation system which the refrigerant fills can be provided.

### BRIEF DESCRIPTION OF DRAWING

FIG. 1 is a schematic diagram illustrating one embodiment of a refrigerating machine.

### DESCRIPTION OF EMBODIMENTS

Hereinafter, an embodiment of the present invention will be described in detail.

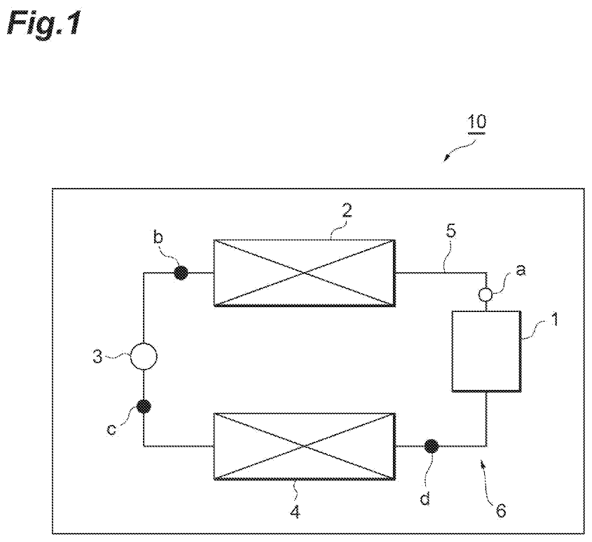

FIG. 1 is a schematic diagram illustrating one embodiment of a refrigerating machine. As illustrated in FIG. 1, a refrigerating machine 10 comprises at least a refrigerant circulation system 6 including a compressor (refrigerant compressor) 1, a condenser (gas cooler) 2, an expansion mechanism (capillary, expansion valve, etc.) 3, and an evaporator (heat exchanger) 4 sequentially connected with piping with a flow passage 5. A refrigerant containing trifluoroiodomethane is used as a refrigerant. A refrigerating machine oil containing, as a base oil, a polyolester synthesized from a polyhydric alcohol and fatty acids, with a proportion of a fatty acid having 9 carbon atoms in the fatty acids being 65 mol % or less is used as a refrigerating machine oil. The temperature of the entire area of the refrigerant circulation system 6 is kept at 160° C. or lower during operation of the refrigerant circulation system 6.

In the refrigerant circulation system 6, the refrigerant at a high temperature discharged from the compressor 1 into the flow passage 5 firstly becomes a high-density fluid (supercritical fluid or the like) in the condenser 2. Subsequently, the refrigerant liquefies as the refrigerant passes through a narrow flow passage having the expansion mechanism 3, and further gasifies in the evaporator 4, and the temperature thereof decreases. Cooling by the refrigerating machine 10 utilizes the phenomenon of the refrigerant taking heat from surroundings when the refrigerant gasifies in the evaporator 4.

In the compressor 1, a small amount of the refrigerant and a large amount of the refrigerating machine oil coexist under a high temperature condition. The refrigerant discharged from the compressor 1 into the flow passage 5 is in a gaseous state and contains a small amount (usually, 1% to 10% by volume) of the refrigerating machine oil as mist, with a small amount of the refrigerant dissolving in this mist-like refrigerating machine oil (point a in FIG. 1).

In the condenser 2, the gaseous refrigerant is compressed and becomes a high-density fluid, and a large amount of the refrigerant and a small amount of the refrigerating machine oil coexist under a relatively high temperature condition (point b in FIG. 1). Furthermore, the mixture of the large amount of the refrigerant and the small amount of the refrigerating machine oil is sent to the expansion mechanism 3 and the evaporator 4 in sequence and the temperature thereof rapidly decreases (points c and d in FIG. 1), and the mixture is returned to the compressor 1 again.

The refrigerant circulation system 6 has, for example, a member formed of an organic polymer material. More specifically, the member formed of an organic polymer material is used for a sealing member for preventing leakage of the refrigerant and refrigerating machine oil at an insulation part in the compressor 1 or in the compressor 1, for example.

The refrigerant fills the refrigerant circulation system 6. A refrigerant containing trifluoroiodomethane is used as the refrigerant. The refrigerant is not particularly limited as long as the refrigerant contains trifluoroiodomethane, and may contain only trifluoroiodomethane and may further contain a refrigerant other than trifluoroiodomethane. The content of trifluoroiodomethane is preferably 10% by mass or more, more preferably 20% by mass or more, and still more preferably 30% by mass or more based on the total amount of the refrigerant. In addition, the content of trifluoroiodomethane is preferably 100% by mass or less, more preferably 50% by mass or less, and still more preferably 40% by mass or less based on the total amount of the refrigerant.

Examples of the refrigerant other than trifluoroiodomethane include a saturated fluorohydrocarbon refrigerant, an unsaturated fluorohydrocarbon refrigerant, a hydrocarbon refrigerant, a fluorine-containing ether-based refrigerant such as perfluoroethers, a bis(trifluoromethyl)sulfide refrigerant, and a natural substance-based refrigerant such as ammonia, carbon dioxide, etc., and a mixed refrigerant of two or more kinds selected from these refrigerants.

Examples of the saturated fluorohydrocarbon refrigerant include saturated fluorohydrocarbons preferably having 1 to 3 carbon atoms and more preferably having 1 to 2 carbon atoms. Specific examples thereof include difluoromethane (R32), trifluoromethane (R23), pentafluoroethane (R125), 1,1,2,2-tetrafluomethane (R134), 1,1,1,2-tetrafluoroethane (R134a), 1,1,1-trifluoroethane (R143a), 1,1-difluoroethane (R152a), fluoroethane (R161), 1,1,1,2,3,3,3-heptafluoropropane (R227ea), 1,1,1,2,3,3-hexafluoropropane (R236ea), 1,1,1,3,3,3-hexafluoropropane (R236fa), 1,1,1,3,3-pentafluoropropane (R245fa), and 1,1,1,3,3-pentafluorobutane (R365mfc), or a mixture of two or more kinds thereof.

While the saturated fluorohydrocarbon refrigerant is selected, as appropriate, from those described above according to application and required performance, preferable examples thereof include R32 singly; R23 singly; R134a singly; R125 singly; mixtures of R134a/R32=60 to 80 mass %/40 to 20 mass %; mixtures of R32/R125=40 to 70 mass %/60 to 30 mass %; mixtures of R125/R143a=40 to 60 mass %/60 to 40 mass %; the mixture of R134a/R32/R125=60 mass %/30 mass %/10 mass %; mixtures of R134a/R32/R125=40 to 70 mass %/15 to 35 mass %/5 to 40 mass %; and mixtures of R125/R134a/R143a=35 to 55 mass %/1 to 15 mass %/40 to 60 mass %. More specifically, the mixture of R134a/R32=70/30 mass %; the mixture of R32/R125=60/40 mass %; the mixture of R32/R125=50/50 mass % (R410A); the mixture of R32/R125=45/55 mass % (R410B); the mixture of R125/R143a=50/50 mass % (R507C); the mixture of R32/R125/R134a=30/10/60 mass %; the mixture of R32/R125/R134a=23/25/52 mass % (R407E); the mixture of R125/R134a/R143a=44/4/52 mass % (R404A); and the like can be used.

Preferable examples of the mixed refrigerant of trifluoroiodomethane and the saturated fluorohydrocarbon refrigerant include an R32/R125/trifluoroiodomethane mixed refrigerant and an R32/R410A/trifluoroiodomethane mixed refrigerant. The ratio of R32:trifluoroiodomethane in such mixed refrigerants is preferably 10 to 90:90 to 10, more preferably 30 to 70:70 to 30, still more preferably 40 to 60:60 to 40, and especially preferably 50 to 60:50 to 40 in view of the balance among compatibility with refrigerating machine oil, low GWP, and incombustibility. Similarly, the ratio of a mixed refrigerant of R32 and trifluoroiodomethane:R125 is preferably 10 to 95:90 to 5 and, from the viewpoint of low GWP, is more preferably 50 to 95:50 to 5 and still more preferably 80 to 95:20 to 5.

The unsaturated fluorohydrocarbon (HFO) refrigerant is preferably fluoropropenes and more preferably fluoropropenes having three to five fluorine atoms. Specifically, it is preferable that the unsaturated fluorohydrocarbon refrigerant be a mixture of any one kind or two or more kinds of 1,2,3,3,3-pentafluoropropene (HFO-1225ye), 1,3,3,3-tetrafluoropropene (HFO-1234ze), 2,3,3,3-tetrafluoropropene (HFO-1234yf), 1,2,3,3-tetrafluoropropene (HFO-1234ye), and 3,3,3-trifluoropropene (HFO-1243zf). From the viewpoint of physical properties of the refrigerant, it is preferable that the unsaturated fluorohydrocarbon refrigerant be one kind or two or more kinds selected from HFO-1225ye, HFO-1234ze, and HFO-1234yf.

The hydrocarbon refrigerant is preferably hydrocarbons having 1 to 5 carbon atoms and more preferably hydrocarbons having 2 to 4 carbon atoms. Specific examples of the hydrocarbons include methane, ethylene, ethane, propylene, propane (R290), cyclopropane, normal butane, isobutane, cyclobutane, methylcyclopropane, 2-methylbutane, normal pentane, or a mixture of two or more kinds thereof. Among them, those which are gas at 25° C. and one atmosphere are preferably used, and propane, normal butane, isobutane, 2-methylbutane, or a mixture thereof is preferable.

Besides the refrigerant, a refrigerating machine oil fills (that is, a working fluid composition for a refrigerating machine, containing the refrigerant and a refrigerating machine oil fills) the refrigerant circulation system 6. The refrigerating machine oil includes a polyolester as a base oil.

The polyolester is an ester synthesized from a polyhydric alcohol and a fatty acid. Saturated fatty acids are preferably used as the fatty acid. The number of carbon atoms of the fatty acid is preferably 4 to 20, more preferably 4 to 18, still more preferably 4 to 9, especially preferably 5 to 9, and extremely preferably 8 to 9. The polyolester may be a partial ester in which a part of hydroxy groups of the polyhydric alcohol remains as a hydroxy group without being esterified, may be a complete ester in which all hydroxy groups are esterified, or may be a mixture of a partial ester and a complete ester.

Among the fatty acid constituting the polyolester, examples of the fatty acids having 4 to 20 carbon atoms include butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, and icosanoic acid. These fatty acids may be linear or branched. The fatty acid is preferably fatty acids having a branch at the α-position and/or β-position, is more preferably branched fatty acids having 4 to 9 carbon atoms, is specifically selected from 2-methylpropanoic acid, 2-methylbutanoic acid, 2-methylpentanoic acid, 2-methylhexanoic acid, 2-ethylpentanoic acid, 2-ethylheptanoic acid, 2-ethylhexanoic acid, 3,5,5-trimethylhexanoic acid, and 2-ethylhexadecanoic acid, and preferably selected from 2-ethylhexanoic acid and 3,5,5-trimethylhexanoic acid.

Among the fatty acids constituting the polyolester according to the present embodiment, the proportion of fatty acid having 9 carbon atoms is required to be 65 mol % or less. When the proportion of fatty acid having 9 carbon atoms is 65 mol % or less, generation of fatty acid having 9 carbon atoms due to decomposition of the polyolester is reduced in the co-presence with the refrigerant containing trifluoroiodomethane, and increase in acid number is suppressed. From such viewpoints, among the fatty acids constituting the polyolester, the proportion of fatty acid having 9 carbon atoms is preferably 60 mol % or less and more preferably 55 mol % or less. In addition, from the viewpoints of maintaining kinetic viscosity and of low temperature properties, the proportion of fatty acid having 9 carbon atoms is preferably 20 mol % or more, more preferably 40 mol % or more, and still more preferably 45 mol % or more.

In addition, the fatty acid may include fatty acids other than the above-mentioned fatty acids having 4 to 20 carbon atoms. The fatty acids other than the fatty acids having 4 to 20 carbon atoms may be fatty acids having 21 to 24 carbon atoms, for example. The fatty acids having 21 to 24 carbon atoms may be, heneico acid, docosanoic acid, tricosanoic acid, and tetracosanoic acid, etc. and may be linear or branched.

As the polyolester according to the present embodiment, it is preferable that a polyolester synthesized from a fatty acid having 8 carbon atoms and a fatty acid having 9 carbon atoms be used. When a polyolester synthesized from a fatty acid having 8 carbon atoms and a fatty acid having 9 carbon atoms is used, it is more preferable that the proportion of the fatty acid having 8 carbon atoms be 40 to 80 mol % and the fatty acid having 9 carbon atoms be 20 to 60 mol % among the fatty acids constituting the polyolester.

As the polyhydric alcohol constituting the polyolester, a polyhydric alcohol having two to six hydroxy groups is preferably used. The number of carbon atoms in the polyhydric alcohol is preferably 4 to 12 and more preferably 5 to 10. The polyhydric alcohol is preferably a hindered alcohol such as neopentyl glycol, trimethylolethane, trimethylolpropane, trimethylolbutane, di-(trimethylolpropane), tri-(trimethylolpropane), pentaerythritol, and dipentaerythritol, for example, and is more preferably pentaerythritol, dipentaerythritol, or a mixed alcohol of pentaerythritol and dipentaerythritol due to their especially excellent compatibility with the refrigerant and hydrolysis stability.

The refrigerating machine oil according to the present embodiment may include only the above-described polyolester as a lubricating base oil, but may include a lubricating base oil other than the above-described polyolester. The content of the above-described polyolester in the lubricating base oil may be 50% by mass or more, 60% by mass or more, 70% by mass or more, 80% by mass or more, or 90% by mass or more based on the total amount of the lubricating base oil.

For such a lubricating base oil, hydrocarbon oils, oxygen-containing oils other than the above-described polyolester, and the like can be used. Examples of the hydrocarbon oils include mineral oil-based hydrocarbon oils and synthetic hydrocarbon oils. Examples of the oxygen-containing oils include esters other than polyolesters, ethers, carbonates, ketones, silicon, and polysiloxane.

The mineral oil-based hydrocarbon oils can be obtained by refining, with a method such as solvent deasphalting, solvent refining, hydrogenation refining, hydrogenation decomposition, solvent dewaxing, hydrogenation dewaxing, white clay treatment, and sulfuric acid washing, the lubricant oil fraction obtained by distilling at normal pressure and distilling under reduced pressure base oil such as paraffin-based base oil and naphthene-based base oil. One kind of these refining methods may be used singly, or two or more kinds thereof may be used in combination.

Examples of the synthetic hydrocarbon oils include alkylbenzenes, alkylnaphthalenes, polyalphaolefins (PAO), polybutenes, and ethylene-α-olefin copolymers.

Examples of the esters other than polyolesters include aromatic esters, dibasic acid esters, complex esters, carbonic acid esters, and mixtures thereof.

Examples of the ethers include polyvinylethers, polyalkyleneglycols, polyphenylethers, perfluoroethers, and mixtures thereof.

From the viewpoint of ensuring lubricity, the kinetic viscosity of the lubricating base oil at 40° C. may be preferably 3 mm²/s or more, more preferably 4 mm²/s or more, and still more preferably 5 mm²/s or more. From the viewpoint of suppressing viscosity resistance in the compressor, the kinetic viscosity of the lubricating base oil at 40° C. may be preferably 100 mm²/s or less, more preferably 500 mm²/s or less, and still more preferably 400 mm²/s or less. From the viewpoint of ensuring lubricity, the kinetic viscosity of the lubricating base oil at 100° C. may be preferably 1 mm²/s or more and more preferably 2 mm²/s or more. From the viewpoint of suppressing viscosity resistance in the compressor, the kinetic viscosity of the lubricating base oil at 100° C. may be preferably 100 mm²/s or less and more preferably 50 mm²/s or less.

The viscosity index of the lubricating base oil may be 70 or more and may be 200 or less.

The kinetic viscosity and viscosity index in the present invention mean the kinetic viscosity and viscosity index measured in accordance with JIS K2283:2000, respectively.

The content of the lubricating base oil may be 50% by mass or more, 60% by mass or more, 70% by mass or more, 80% by mass or more, or 90% by mass or more based on the total amount of the refrigerating machine oil.

Preferably, the refrigerating machine oil according to the present embodiment may further contain a hindered phenol compound. The hindered phenol compound in the present description is a compound having a structure in which at least one hydroxy group and at least one, preferably two tert-butyl groups are bonded to adjacent positions on the benzene ring. Examples of the hindered phenol compound include 2,6-di-tert-butyl-p-cresol (DBPC), 2,6-di-tert-butyl-phenol, 4,4′-methylenebis(2,6-di-tert-butyl-phenol), and a group of compounds having similar structures thereof, and DBPC is preferably used. From the viewpoint of further excellent stability of the refrigerating machine oil, the content of the hindered phenol compound may be preferably 0.01% by mass or more, more preferably 0.05% by mass or more, and still more preferably 0.1% by mass or more based on the total amount of the refrigerating machine oil. There is no particular limitation on an upper limit of the content of the hindered phenol compound, and the content is usually 5% by mass or less based on the total amount of the refrigerating machine oil; however, from the viewpoint of suppressing coloring of the refrigerating machine oil at the time when air gets mixed in therewith, he content may be preferably 0.5% by mass or less, more preferably 0.3% by mass or less, and still more preferably 0.2% by mass or less based on the total amount of the refrigerating machine oil.

Preferably, the refrigerating machine oil according to the present embodiment may further contain an acid scavenger.

Examples of the acid scavenger include epoxy compounds (epoxy-based acid scavengers). Examples of the epoxy compounds include glycidyl ether-type epoxy compounds, glycidyl ester-type epoxy compounds, aryloxysilane compounds, alkyloxysilane compounds, alicyclic epoxy compounds, epoxidized fatty acid monoesters, and epoxidized plant oils. One kind of these acid scavengers can be used alone, or two or more kinds thereof can be used in combination.

As the glycidyl ether-type epoxy compounds, aryl glycidyl ether-type epoxy compounds or alkyl glycidyl ether-type epoxy compounds represented by the following formula (1) can be used, for example.

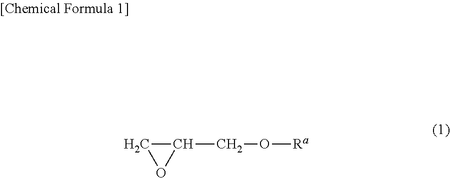

[In formula (1), R^{a} represents an aryl group or an alkyl group having 5 to 18 carbon atoms.]

As the glycidyl ether-type epoxy compounds represented by formula (1), phenyl glycidyl ether, n-butylphenyl glycidyl ether, i-butylphenyl glycidyl ether, sec-butylphenyl glycidyl ether, tert-butylphenyl glycidyl ether, pentylphenyl glycidyl ether, hexylphenyl glycidyl ether, heptylphenyl glycidyl ether, octylphenyl glycidyl ether, nonylphenyl glycidyl ether, decylphenyl glycidyl ether, decyl glycidyl ether, undecyl glycidyl ether, dodecyl glycidyl ether, tridecyl glycidyl ether, tetradecyl glycidyl ether, and 2-ethylhexyl glycidyl ether, are preferable.

When the number of carbon atoms of the alkyl group represented by R^{a} is five or more, stability of epoxy compounds is ensured, and decomposition before reaction with moisture, fatty acids, or oxidized deteriorated substances or self-polymerization between epoxy compounds can be suppressed, making it easier to obtain a function as the acid scavenger. On the other hand, when the number of carbon atoms of the alkyl group represented by R^{a} is 18 or less, good solubility with the refrigerant is maintained, being capable of making it harder for failure such as cooling failure (reduction in heat exchange efficiency) or deterioration in performance of the refrigerating machine oil due to precipitation in the refrigeration device to occur.

As the glycidyl ether-type epoxy compounds, neopentyl glycol diglycidyl ether, trimethylolpropane triglycidyl ether, pentaerythritol tetraglycidyl ether, 1,6-hexanediol diglycidyl ether, sorbitol polyglycidyl ether, polyalkylene glycol monoglycidyl ether, polyalkylene glycol diglycidyl ether, etc. can also be used in addition to the compounds represented by formula (1).

As the glycidyl ester-type epoxy compounds, those represented by the following formula (2) can be used, for example.

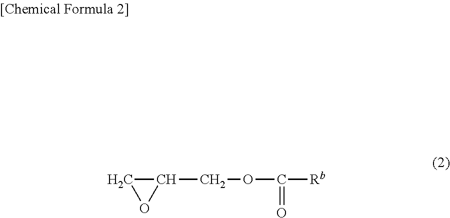

In formula 2, R^{b} represents an aryl group, an alkyl group or an alkenyl group having 5 to 18 carbon atoms.

As the glycidyl ester-type epoxy compounds represented by formula (2), glycidyl benzoate, glycidyl neodecanoate, glycidyl-2,2-dimethyl octanoate, glycidyl acrylate, and glycidyl methacrylate are preferable.

When the number of carbon atoms of the alkyl group represented by R^{b} is five or more, stability of epoxy compounds is ensured, and decomposition before reaction with moisture, fatty acids, or oxidized deteriorated substances or occurrence of self-polymerization between epoxy compounds can be suppressed, making it easier to obtain an intended function. On the other hand, when the number of carbon atoms of the alkyl group or alkenyl group represented by R^{b} is 18 or less, good solubility with the refrigerant is maintained, being capable of making it harder for failure such as cooling failure due to precipitation in the refrigeration device to occur.

The alicyclic epoxy compounds are compounds having a partial structure represented by the following formula (3) in which carbon atoms constituting the epoxy group directly constitute an alicyclic ring.

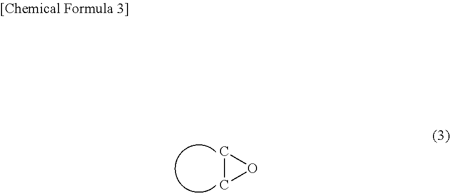

As the alicyclic epoxy compounds, 1,2-epoxycyclohexane, 1,2-epoxycyclopentane, 3′,4′-epoxycyclohexylmethyl-3,4-epoxycyclohexanecarboxylate, bis(3,4-epoxycyclohexylmethyl)adipate, exo-2,3-epoxynorbornane, bis(3,4-epoxy-6-methylcyclohexylmethyl)adipate, 2-(7-oxabicyclo[4.1.0])hept-3-yl)-spiro(1,3-dioxane-5,3′-[7]oxabicyclo[4.1.0]heptane, 4-(1′-methylepoxyethyl)-1,2-epoxy-2-methylcyclohexane, and 4-epoxyethyl-1,2-epoxycyclohexane are preferable, for example.

Examples of the aryloxysilane compounds can include 1,2-epoxystyrene and alkyl-1,2-epoxystyrene.

Examples of the alkyloxysilane compounds can include 1,2-epoxybutane, 1,2-epoxypentane, 1,2-epoxyhexane, 1,2-epoxyheptane, 1,2-epoxyoctane, 1,2-epoxynonane, 1,2-epoxydecane, 1,2-epoxyundecane, 1,2-epoxydodecane, 1,2-epoxytridecane, 1,2-epoxytetradecane, 1,2-epoxypentadecane, 1,2-epoxyhexadecane, 1,2-epoxyheptadecane, 1,1,2-epoxyoctadecane, 2-epoxynonadecane, and 1,2-epoxyicosane, for example.

Examples of the epoxidized fatty acid monoesters can include esters of an epoxidized fatty acid having 12 to 20 carbon atoms and an alcohol having 1 to 8 carbon atoms or phenol or alkyl phenol. As the epoxidized fatty acid monoesters, butyl, hexyl, benzyl, cyclohexyl, methoxyethyl, octyl, phenyl, and butylphenylesters of epoxystearic acids are preferably used.

Examples of the epoxidized plant oils can include epoxy compounds of plant oils such as soybean oil, flaxseed oil, and cotton oil.

The acid scavenger is preferably at least one kind selected from the glycidyl ester-type epoxy compounds and the glycidyl ether-type epoxy compounds and is preferably at least one kind selected from the glycidyl ester-type epoxy compounds from the viewpoint of excellent compatibility with resin materials used for members in the refrigerating machine.

The content of the acid scavenger is preferably 0.01% by mass or more, more preferably 0.1% by mass or more, and still more preferably 0.3% by mass or more based on the total amount of the refrigerating machine oil. In addition, the content of the acid scavenger is preferably 5% by mass or less, more preferably 3% by mass or less, and still more preferably 2% by mass or less based on the total amount of the refrigerating machine oil.

The refrigerating machine oil according to the present embodiment may further contain other additives. Examples of the other additives include antioxidants such as amine-based antioxidants, extreme pressure agents, oiliness agents, defoaming agents, metal deactivation agents, anti-wear agents, viscosity index improvers, pour point depressants, and detergent dispersants. The contents of these additives may be 10% by mass or less or 5% by mass or less based on the total amount of the refrigerating machine oil.

From the viewpoint of ensuring lubricity, the kinetic viscosity of the refrigerating machine oil at 40° C. may be preferably 3 mm²/s or more, more preferably 4 mm²/s or more, still more preferably 5 mm²/s or more. From the viewpoint of suppressing viscosity resistance in the compressor, the kinetic viscosity of the refrigerating machine oil at 40° C. may be preferably 500 mm²/s or less, more preferably 400 mm²/s or less, and still more preferably 300 mm²/s or less. From the viewpoint of ensuring lubricity, the kinetic viscosity of the refrigerating machine oil at 100° C. may be preferably 1 mm²/s or more and more preferably 2 mm²/s or more. From the viewpoint of suppressing viscosity resistance in the compressor, the kinetic viscosity of the refrigerating machine oil at 100° C. may be preferably 100 mm²/s or less and more preferably 50 mm²/s or less.

The viscosity index of the refrigerating machine oil may be 70 or more and may be 200 or less.

The pour point of the refrigerating machine oil may be preferably −10° C. or less and more preferably −20° C. or less. The pour point in the present invention means the pour point measured in accordance with JIS K2269:1987.

The volume resistivity of the refrigerating machine oil may be preferably 1.0×10⁹ Ω·m or more, more preferably 1.0×10¹⁰ ∩·m or more, and still more preferably 1.0×10¹¹ Ω·m or more. The volume resistivity in the present invention means the volume resistivity measured at 25° C. in accordance with JIS C2101:1999.

The water content of the refrigerating machine oil is preferably 1200 ppm or less, more preferably 600 ppm or less, still more preferably 100 ppm or less, and especially further preferably 50 ppm or less based on the total amount of the refrigerating machine oil. When the water content of the refrigerating machine oil falls within the above numerical range, increase in the acid number of the refrigerating machine oil is more effectively suppressed for a long period, and the effect of the present invention is more significantly provided. The water content in the present invention means the water content measured in accordance with JIS K2275 (Karl Fischer titration method).

The acid number of the refrigerating machine oil may be preferably 1.0 mgKOH/g or less and more preferably 0.1 mgKOH/g or less. When the acid number of the refrigerating machine oil is 1.0 mgKOH/g or less, chemical stability can be more surely ensured. The hydroxy number of the refrigerating machine oil is usually 0 to 100 mgKOH/g, preferably 50 mgKOH/g or less, more preferably 20 mgKOH/g or less, and still more preferably 10 mgKOH/g or less, and may be preferably 0.1 mgKOH/g or more and more preferably 0.5 mgKOH/g or more. When the hydroxy number of the refrigerating machine oil is 100 mgKOH/g or less, insulation performance of the refrigerating machine oil can be more surely ensured, and when the hydroxy number of the refrigerating machine oil is 0 mgKOH/g or more, solubility in the refrigerant can be more sufficiently ensured. The acid number in the present invention means the acid number measured in accordance with JIS K2501:2003, and the hydroxy number in the present invention means the hydroxy number measured in accordance with JIS K0070.

The ash content of the refrigerating machine oil may be preferably 100 ppm or less and more preferably 50 ppm or less. The ash content in the present invention means the ash content measured in accordance with JIS K2272:1998.

In the method for operating the refrigerant circulation system 6 according to the present embodiment, the temperature of the entire area of the refrigerant circulation system 6 is required to be kept at 160° C. or lower. By virtue of keeping the temperature of the entire area of the refrigerant circulation system 6 at 160° C. or lower, it becomes possible to significantly suppress deterioration of the refrigerant containing trifluoroiodomethane and of the refrigerating machine oil used together with the refrigerant. From such a viewpoint, the temperature of the entire area of the refrigerant circulation system 6 is preferably 150° C. or lower. The lower limit of the temperature of the entire area of the refrigerant circulation system 6 may be −100° C., for example, but is not particularly limited thereto. Keeping the temperature of the entire area of the refrigerant circulation system 6 at 160° C. or lower means that the temperature of a working fluid composition for the refrigerating machine circulating in the refrigerant circulation system 6 is controlled so as to be 160° C. or lower, and even when there is a local heat generation in the refrigerating machine, the temperature of the working fluid composition for the refrigerating machine only needs to be kept at 160° C. or lower throughout the refrigerant circulation system 6.

As described above, examples of the method for keeping the temperature of the entire area of the refrigerant circulation system 6 at 160° C. or lower include setting the temperature in the compressor 1 in which the temperature becomes highest in the refrigerant circulation system 6 to 160° C. or lower.

Examples of factors of controlling the temperature in the compressor 1 include the filling amount of the refrigerant (the temperature increases when it is small), the inflow amount of the refrigerant into the compressor (the temperature increases when it is small), the discharged amount of the refrigerant from the compressor (the temperature increases when it is large), the filling amount of the refrigerating machine oil (the temperature increases when it is small), the hydraulic pressure in the compressor (the temperature increases when it is high), the rotating speed of the compressor (the temperature increases when it is high), and mixing of moisture or air into the compressor (the temperature increases when it is great). By appropriately setting and managing these controlling factors according to the specifications of the refrigerant circulation system 6, the temperature thereof can be kept at 160° C. or lower.

Examples of a refrigerating machine 10 comprising the refrigerant circulation system 6 according to the present embodiment include air conditioners for automobiles, dehumidifiers, refrigerators, freezing and refrigerating warehouses, vending machines, showcases, cooling systems in chemical plants and the like, residential air conditioners, packaged air conditioners, and heat pumps for hot water supply.

### EXAMPLES

Hereinafter, the present invention will be described more specifically on the basis of Examples, but the present invention is not limited to the following Examples.

[Lubricating Base Oil]

Base oil A: A polyolester (kinetic viscosity at 40° C.: 68 mm²/s, viscosity index: 88) of pentaerythritol and a fatty acid mixture of 2-ethylhexanoic acid/3,5,5-trimethylhexanoic acid (mole ratio: 48/52) was prepared.

Base oil B: A polyolester (kinetic viscosity at 40° C.: 68 mm²/s, viscosity index: 90) of pentaerythritol and a fatty acid mixture of 2-ethylhexanoic acid/3,5,5-trimethylhexanoic acid (mole ratio: 44/56) was prepared.

Base oil C: A polyolester (kinetic viscosity at 40° C.: 70 mm²/s, viscosity index: 90) of pentaerythritol and a fatty acid mixture of 2-ethylhexanoic acid/3,5,5-trimethylhexanoic acid/normal hexanoic acid (mole ratio: 38/57/5) was prepared.

[Refrigerating Machine Oil]

To the above-described lubricating base oil were added 0.3% by mass of a hindered phenol (DBPC) and 0.7% by mass of an acid scavenger (glycidyl neodecanoate) based on the total amount of the refrigerating machine oil to prepare a refrigerating machine oil.

[Refrigerant]

As a refrigerant containing trifluoroiodomethane, difluoromethane (R32), the 50/50 mass % mixture of difluoromethane (R32)/pentafluoroethane (R125) (R410A), and trifluoroiodomethane were mixed to prepare a mixed refrigerant containing R32, R125, and trifluoroiodomethane (mixing ratio (mass ratio): R32/R410A/trifluoroiodomethane=37.5/23/39.5) (R32/R125/trifluoroiodomethane=49.0/11.5/39.5). The mixed refrigerant having this composition is thought to have a GWP of 733 and is thought to belong to non-flammable refrigerant (A1) in categories according to ASHRAE.

### Examples 1 to 9 and Comparative Examples 1 to 3

The following tests were carried out using the above refrigerating machine oils and refrigerant.

In an autoclave, 30 g of each refrigerating machine oil (initial hue L 0.5, initial acid number 0.01 mgKOH/g or less) prepared such that the water content became the corresponding amount shown in the following Table 1 to Table 3, 30 g of the refrigerant prepared as described above, and catalysts of 0.6 mmφ×50 mm (copper, iron, aluminum, one each) were placed in a 200 ml autoclave, which was heated to the corresponding temperature shown in Table 1 and kept for 168 hours. The hue (ASTM D156) and acid number of each of the refrigerating machine oils after 168 hours were measured. Results are shown in Table 1 to Table 3.

TABLE 1

| | | Example 1 | Example 2 | Example 3 | Example 4 | Example 5 |
|---|---|---|---|---|---|---|
| Lubricating base oil | | Base oil A | Base oil A | Base oil A | Base oil B | Base oil B |
| Water content | ppm | 30 | 540 | 1080 | 30 | 540 |
| of refrigerating | | | | | | |
| machine oil | | | | | | |
| Test | ° C. | 150 | 150 | 150 | 150 | 150 |
| temperature | | | | | | |
| Hue | ASTM D156 | L 0.5 | L 0.5 | L 0.5 | L 0.5 | L 0.5 |
| Acid number | mgKOH/g | 0.02 | 0.05 | 0.06 | 0.02 | 0.04 |

TABLE 2

| | | Example 6 | Example 7 | Example 8 | Example 9 |
|---|---|---|---|---|---|
| Lubricating base oil | | Base oil C | Base oil C | Base oil A | Base oil A |
| Water | ppm | 30 | 540 | 30 | 30 |
| content of | | | | | |
| refrigerating | | | | | |
| machine oil | | | | | |
| Test | ° C. | 150 | 150 | 130 | 100 |
| temperature | | | | | |
| Hue | ASTM | L 0.5 | L 0.5 | L 0.5 | L 0.5 |
| | D156 | | | | |
| Acid number | mgKOH/g | 0.02 | 0.05 | 0.02 | 0.02 |

TABLE 3

| | | Comparative | Comparative | Comparative |
|---|---|---|---|---|
| | | Example 1 | Example 2 | Example 3 |
| Lubricating base oil | | Base oil A | Base oil A | Base oil A |
| Water content | ppm | 30 | 540 | 1080 |
| of refrigerating | | | | |
| machine oil | | | | |
| Test temperature | ° C. | 175 | 175 | 175 |
| Hue | ASTM | D 8.0 | D 8.0 | D 8.0 |
| | D156 | | | |
| Acid number | mgKOH/g | 11.0 | 9.4 | 8.0 |

### REFERENCE SIGNS LIST

1 . . . compressor, 2 . . . condenser, 3 . . . expansion mechanism, 4 . . . evaporator, 5 . . . flow passage, 6 . . . refrigerant circulation system, 10 . . . refrigerating machine

1. A method for operating a refrigerant circulation system comprising a compressor, a condenser, an expansion mechanism, and an evaporator connected in this order with piping, wherein
a refrigerant comprising trifluoroiodomethane is used;
a refrigerating machine oil comprising, as a base oil, a polyolester synthesized from a polyhydric alcohol and fatty acids, with a proportion of a fatty acid having 9 carbon atoms in the fatty acids being 65 mol % or less is used; and
a temperature of an entire area of the refrigerant circulation system is kept at 160° C. or lower.

2. The method according to claim 1, wherein the refrigerating machine oil further comprises a hindered phenol compound.

3. The method according to claim 1, wherein the refrigerating machine oil further comprises an acid scavenger.
